(19) United States
(12) Patent Application Publication
(10) Pub. No.: US 2019/0320244 A1
(43) Pub. Date: Oct. 17, 2019

(54) SENSOR MODULE SYSTEM

(71) Applicant: Nidec Motor Corporation, St. Louis, MO (US)

(72) Inventors: Timothy R. Albers, St. Charles, MO (US); Pranesh Rao, Chesterfield, MO (US); Thomas Schardt, Edwardsville, IL (US); Suresh Kumar V, Hyderabad (IN); Sarang Kalbande, Nagpur City (IN); Satyadeep Kumar Gupta, Bhubaneswar (IN); Sambath Kumar B, Hyderbad (IN)

(73) Assignee: Nidec Motor Corporation, St. Louis, MO (US)

(21) Appl. No.: 16/385,544

(22) Filed: Apr. 16, 2019

Related U.S. Application Data
(60) Provisional application No. 62/658,412, filed on Apr. 16, 2018.

(51) Int. Cl. H04Q 9/00; H04L 29/08; H04L 12/26

(52) U.S. Cl. CPC H04Q 9/00; H04Q 2209/823; H04L 43/045; H04L 67/12

(57) ABSTRACT

A system and method for monitoring health of equipment. One step of the method includes securing a plurality of sensor modules on to a plurality of pieces of equipment. Each sensor module is secured on to a separate piece of equipment. An additional step includes generating, by each sensor module, sensor data related to the piece of equipment on to which the sensor module is secured. The sensor data includes vibration data for the piece of equipment, temperature data for the piece of equipment, and temperature data for a location exterior to the piece of equipment. An additional step includes processing, by each sensor module, the sensor data generated by the sensor module into a data packet, with the data packet including the sensor data. An additional step includes transmitting the data packet from each sensor module to a gateway over a local communications network. A further step includes transmitting the sensor data from the gateway to a server device.

### RELATED APPLICATION

The present non-provisional patent application claims priority to U.S. Provisional Patent Application No. 62/658,412, filed Apr. 16, 2018, and entitled MOTOR SENSOR MODULE, the entire disclosure of which is hereby incorporated by reference into the present non-provisional patent application.

### CROSS-REFERENCE TO CONTEMPORANEOUSLY FILED APPLICATION

This non-provisional patent application is being filed contemporaneously with U.S. Non-Provisional patent application Ser. No. ______, entitled “SENSOR MODULE,” the entire disclosure of which is hereby incorporated by reference into the present non-provisional patent application

### FIELD OF THE INVENTION

Embodiments of the present invention are generally directed to a sensor module. More particularly, embodiments of the present invention are directed to a sensor module configured to be attached to a piece of equipment, such as a motor, and to obtain sensor data relevant to the piece of equipment. Embodiments of the present invention are further directed to a sensor module system, which includes a plurality of sensor modules each configured to obtain sensor data for a piece of equipment and to transmit such sensor data for further analysis.

### BACKGROUND OF THE INVENTION

In manufacturing, equipment health is of primary importance. Properly maintained equipment prevents manufacturing disruptions and idle workers. Properly maintained equipment also reduces downtime costs. Many manufacturing facilities incorporate the use of industrial equipment, such as motors, within their manufacturing processes. For a given manufacturing facility, the failure of one or more pieces of equipment can bring the entire manufacturing process to a halt. Unfortunately, such equipment is generally maintained and repaired only at predefined intervals or when issues are clearly manifested (e.g., upon a mechanical failure of a motor). As a result, the poor health of given piece of equipment is generally unknown until a failure occurs.

The use of sensors for monitoring various types of equipment is known. However, such previously-used sensors are generally large, cumbersome units, which are difficult to incorporate with many types of equipment. Additionally, such previously-used sensors were generally only configured to obtain a single type of information for the equipment. Such information would generally be required to be communicated via wired connection from the sensor to another device for analysis. Finally, the information obtained from one of such previously-used sensors would not typically be configured for integration with information from other sensors. As such, any resulting analysis was not sufficiently comprehensive.

### SUMMARY OF THE INVENTION

In one embodiment of the present invention, there is provided a method for monitoring health of equipment. One step of the method includes securing a plurality of sensor modules on to a plurality of pieces of equipment. Each sensor module is secured on to a separate piece of equipment. An additional step includes generating, by each sensor module, sensor data related to the piece of equipment on to which the sensor module is secured. The sensor data includes vibration data for the piece of equipment, temperature data for the piece of equipment, and temperature data for a location exterior to the piece of equipment. An additional step includes processing, by each sensor module, the sensor data generated by the sensor module into a data packet, with the data packet including the sensor data. An additional step includes transmitting the data packet from each sensor module to a gateway over a local communications network. A further step includes transmitting the sensor data from the gateway to a server device.

In yet another embodiment of the present invention, there is provided a sensor module system for monitoring health of equipment. The sensor module system comprises a plurality of sensor modules, each mounted to a piece of equipment. Each sensor module is configured to generate sensor data relevant to the piece of equipment to which the sensor module is mounted. The sensor data includes vibration data for the piece of equipment, temperature data for the piece of equipment, and temperature data for a location exterior to the piece of equipment. Each sensor module is configured to process the sensor data generated by the sensor module into a data packet that includes the sensor data. The sensor module system additionally comprises a gateway configured to receive the data packets from each of the sensor modules. The sensor module system further includes a server device configured to receive, from the gateway, the sensor data for each sensor module.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE FIGURES

Embodiments of the present invention are described herein with reference to the following drawing figures, wherein:

FIG. 1 is a perspective view of a sensor module according to embodiments of the present invention;

FIG. 2 is an additional perspective view of the sensor module from FIG. 1;

FIG. 3 is a cross-section of the sensor module from FIGS. 1 and 2;

FIG. 4 is an exploded view of the sensor module from FIGS. 1-3;

FIG. 5 is a perspective view of a motor and the sensor module from FIGS. 1-4, with the sensor module secured to the motor to obtain sensor data relevant to the motor;

FIG. 6 is a schematic view of a sensor module system according to embodiments of the present invention, with the sensor module system including a plurality of sensor modules as shown in FIGS. 1-4;

FIG. 7 is a perspective cross-section of a base of the sensor module from FIGS. 1-4;

FIG. 8 is an elevation view of the cross-section of the base from FIG. 7;

FIG. 9 is another cross-section of the sensor module from FIGS. 1-4, additionally include a potting material in a portion of an interior space of the sensor module; and

FIG. 10 is a graphical user interface for visualizing sensor data according to embodiments of the present invention.

The drawing figures do not limit the present invention to the specific embodiments disclosed and described herein. While the drawings do not necessarily provide exact dimensions or tolerances for the illustrated components or structures, the drawings are to scale with respect to the relationships between the components of the structures illustrated in the drawings.

### DETAILED DESCRIPTION

The following detailed description of the present invention references various embodiments. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

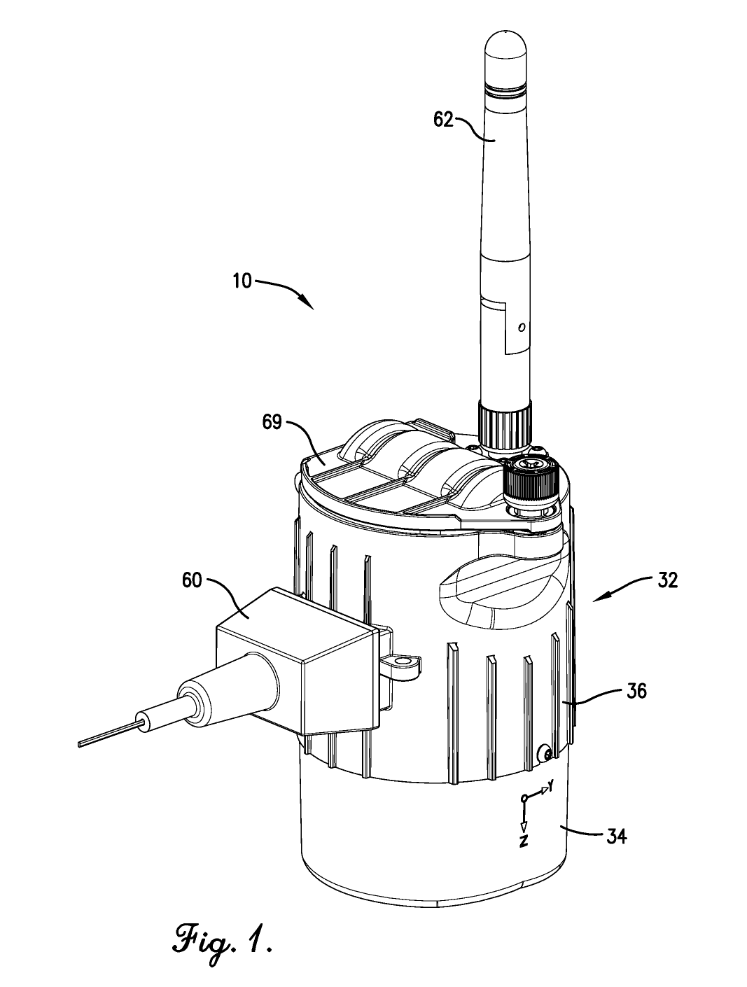

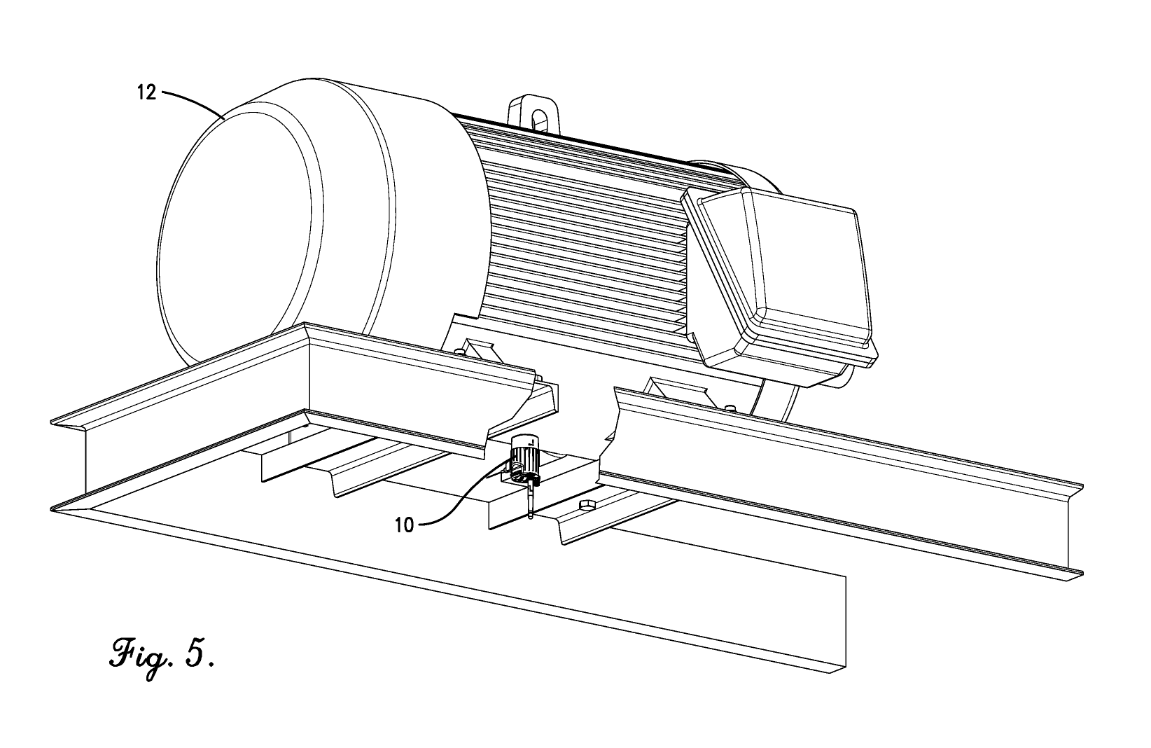

Broadly, embodiments of the present invention are directed to a sensor module 10, as illustrated in FIGS. 1-4, which may be used to obtain physical measurements for a piece of equipment. Such physical measurements may include measurements related to temperatures and accelerations/vibrations experienced by the piece of equipment. Based on the physical measurements, the sensor module 10 can generate sensor data for further analysis. As used herein, the term “sensor data” is used to mean data obtained and/or generated by the sensor module 10. For example, as shown in FIG. 5, the sensor module 10 may be attached to piece of equipment, in the form of a motor 12. In such a configuration, the sensor module can obtain and/or generate various types of sensor data related to the motor 12 and/or relevant to the environment around the motor 12. As will be described in more detail below, in some embodiments, the sensor data will include temperature data relevant to a temperature experienced by the motor 12 and/or a temperature of the environment around the motor, as well as vibration data indicative of vibrations experience by the motor 12.

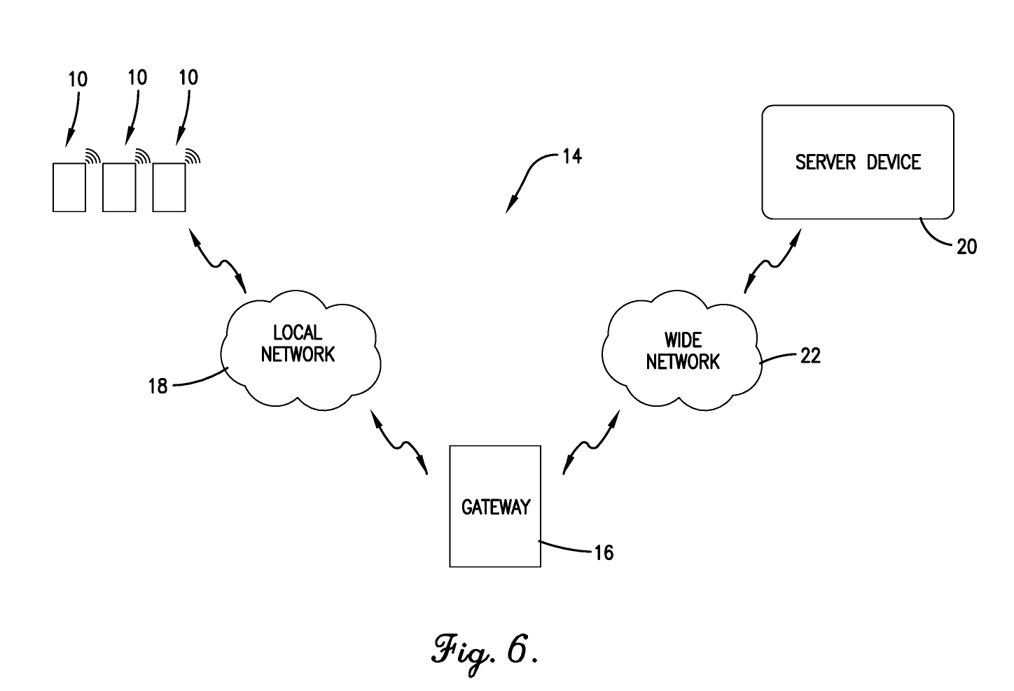

As illustrated in FIG. 6, in some embodiments of the present invention, a plurality of sensor modules 10 may be included as part of a sensor module system 14 (the “SM System 14”). The SM System 14 may comprise the one or more sensor modules 10 in communication with a gateway 16 via a communications network (referred to herein as “local network 18”). The SM System 14 may additionally include a server device 20 in communication with the gateway 16 via a communications network (referred to herein as “wide network 22”). In operation, the sensor modules 10 can each be associated with a piece of equipment (e.g., a motor 12 as shown in FIG. 5) so as to obtain sensor data (e.g., temperature data and/or vibration data) related to the piece of equipment. The sensor modules 10 may each be configured to transmit such sensor data to the gateway 16 over the local network 18. The gateway 16 can further transmit such sensor data over the wide network 22 to the server device 20, such that the sensor data can be aggregated and analyzed. Because the sensor modules 10 may each be connected to a piece of equipment, the analysis of resulting sensor data will allow a user of the SM System 14 to determine equipment health, to identify maintenance issues with the equipment, and/or to preemptively recognize imminent failure of the equipment.

Beginning with the sensor module 10, as illustrated in FIGS. 1-3, the sensor module 10 may comprise a housing 32 enclosing an open interior space. As such, the housing 32 is configured to house or enclose one or more additional components of the sensor module 10. As shown in the drawings, in some embodiments, the housing 32 may be formed as an elongated cylinder with an upper end and a lower end. Nevertheless, it should be understood that the housing 32 may be formed as a container having various other shapes (e.g., rectangular). In some embodiments, the housing 32 will comprise a base 34 and a cap 36, with the cap 36 configured to be removably engaged with base 34. The base 34 includes the lower end of the housing 32, and the cap 36 includes the upper end of the housing 32. When the cap 36 is engaged with the base 34, the housing 32 is configured to enclose the one or more additional components of the sensor module 10, as will be described in more detail below. The cap 36 may be securely engaged with the base 34 via one or more fasteners (e.g., screws) extending simultaneously through the cap 36 and the base 34.

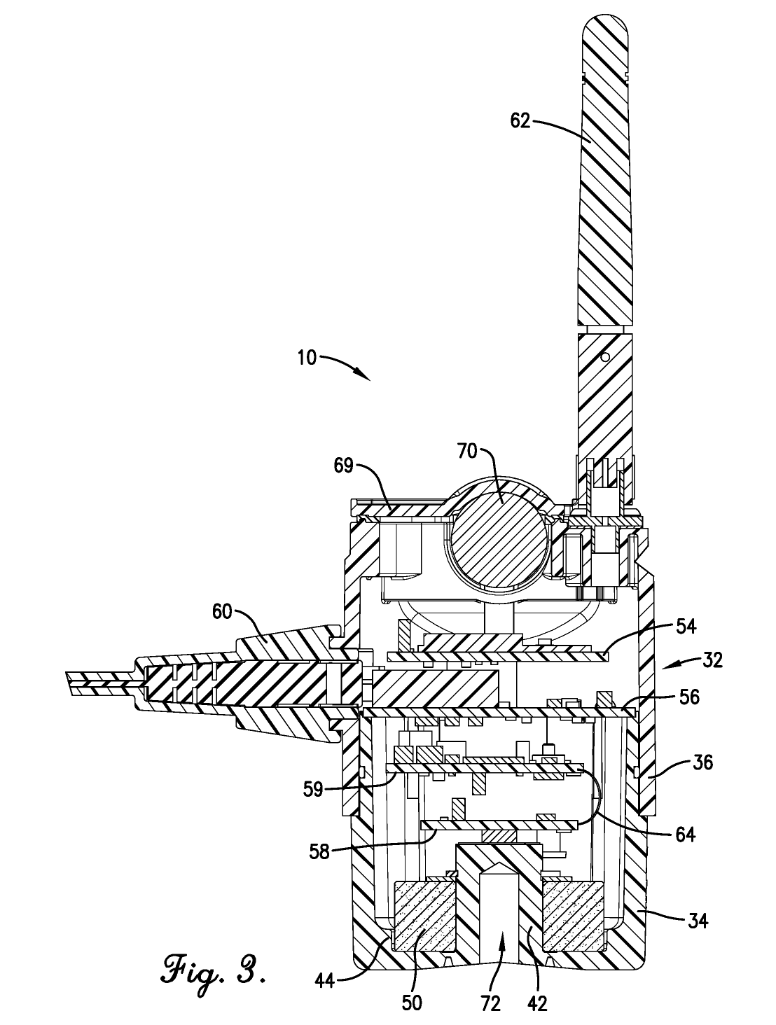

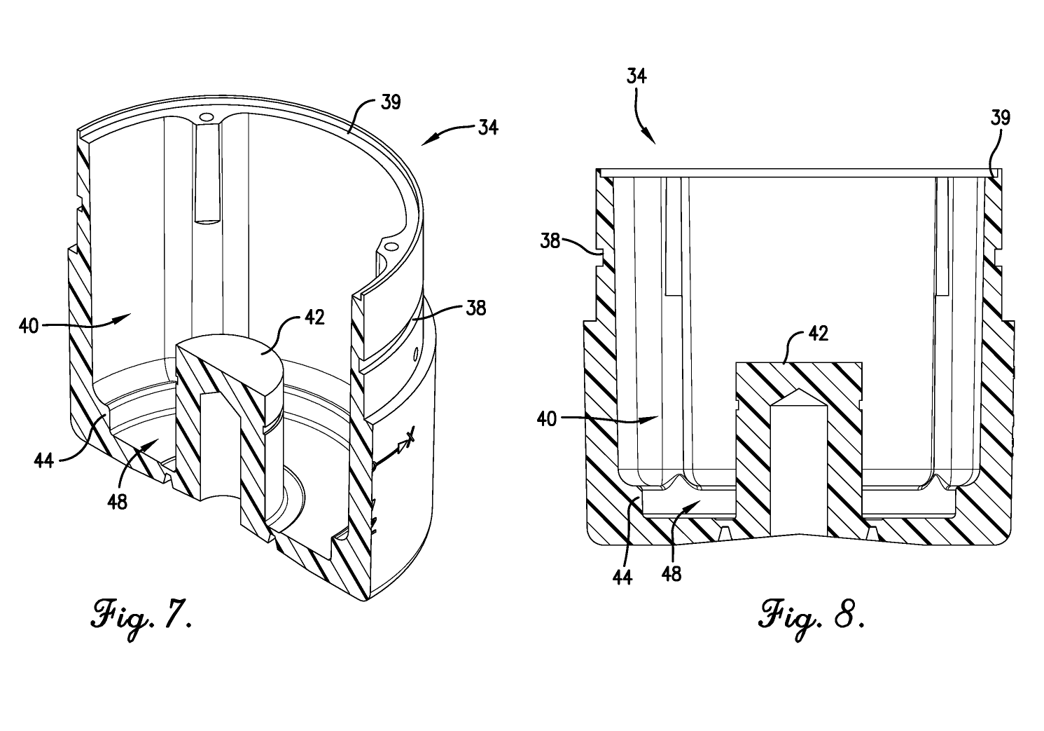

In more detail, the base 34 of the sensor module 10 may be formed in a generally cylindrical shape. As shown in FIGS. 7 and 8, the base 34 may comprise a cylindrical sidewall extending upward from a bottom panel. Likewise, as perhaps best shown in FIG. 3, the cap 36 may comprise a cylindrical sidewall extending downward from a top panel. In some embodiments, a lower portion of the sidewall of the base 34 may be formed with a larger exterior diameter than an upper portion of the base's 34 sidewall. As a result, the cap 36 is configured to be engaged with the base 34 by positioning the sidewall of the cap 36 around the upper portion of the base's 34 sidewall in sleeve-like manner (See, e.g., FIG. 3). Fasteners can then be extended through the sidewall of the cap 36 and the upper portion of the sidewall of the base 34 to secure the base 34 and the cap 36 together to form the housing 32 of the sensor module 10.

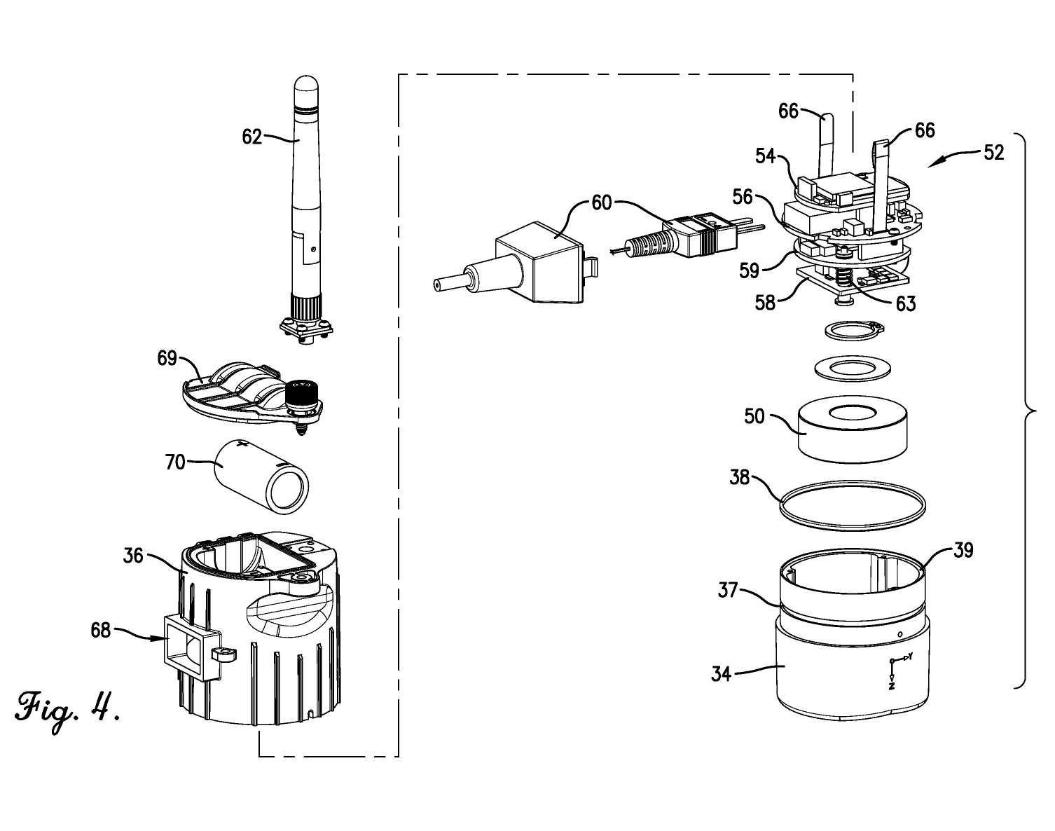

In some embodiments, as shown in FIG. 4, an exterior surface of the upper portion of the base 34 may be formed with an annular groove 37, in which an O-ring 38 may be positioned. In such embodiments, once the cap 36 has been engaged with the base 34, the O-ring 38 will provide a sealing function between the base 34 and the cap 36 to aid in isolating the interior space of the sensor module 10 from the external environment. In some embodiments, the interior space may be isolated from the external environment sufficiently to satisfy an IP-55 rating. As perhaps best shown in FIGS. 7 and 8, an upper end of the base 34 may, in some embodiments, additionally be formed with a flanged mating surface 39 that is recessed lower than the exterior surface of the upper end of the base 34. Such mating surface 39 can be used to secure one or more additional components of the sensor module 10 to the base 34, as will be described in more detail below.

Remaining with FIGS. 7 and 8, a portion of the interior space presented by the base 34 of the sensor module 10 may be in the form of an annular channel 40. The annular channel 40 may be defined between the sidewall of the base 34 and a centrally-positioned post 42 that extends upward from the bottom panel of the base 34. In certain embodiments, a lower part of the lower portion of the sidewall of the base 34 may be formed with a larger thickness that remaining parts of the sidewall, so as to present a shelf 44 that extends further interiorly than the remaining parts of the sidewall of the base 34. The portion of the annular channel 40 defined between the shelf 44 and the post 42 may be referred to as a magnet-receiving trough 48, the purpose of which will be described in more detail in the following paragraph.

In some embodiments, the sensor module 10 may include a mounting assembly for securing the sensor module 10 to the piece of equipment motor (e.g., to the motor 12 of FIG. 5). In some embodiments the mounting assembly will be in incorporated with and/or form part of the base 34 of the sensor module 10. As shown in FIG. 4, the mounting assembly may comprise a magnet 50, which is configured to be positioned within the interior space of the housing 32 of the sensor module 10. In some embodiments, the magnet 50 may comprise a ring magnet which is sized to be received within the annular channel 40, and particularly within the magnet-receiving trough 48, of the base 34. As illustrated in FIG. 3, the magnet 50 may have an inner diameter sized to permit the magnet 50 to be positioned over and/or around the post 42 of the base 34. The width of the magnet 50 (extending between the inner diameter to an outer diameter) may be configured so as to permit the magnet 50 to fit snugly within the magnet-receiving trough 48 defined between the shelf 44 and the post 42 (the trough 48 is not referenced in FIG. 3). As will be described in more detail below, the magnet 50 may function to secure the sensor module 10 to a piece of equipment (e.g., to the motor 12 of FIG. 5). To enhance the ability to make such a connection, in some embodiments, the base 34 of the sensor module 10 may be formed from a paramagnetic material, such as aluminum, which provides sufficient strength and durability to the sensor module 10, but which is not generally affected by the magnetic field created by the magnet 50. In some additional embodiments, it may also be beneficial for the base 34 of the sensor module 10 to formed from a heat-conductive material (e.g., aluminum), such that the base 34 can conduct heat generated by the piece of equipment to which the sensor module 10 is connected.

With reference to FIG. 4, the sensor module 10 may additionally include a data processing assembly 52 that is configured to be at least partially positioned and/or enclosed within the interior space of the housing 32 of the sensor module 10. The data processing assembly 52 may include a plurality of electronics boards (e.g., printed circuit boards), each being configured to obtain, process, and/or transmit data. For example, the data processing assembly 52 may include an electronics board in the form of a communications element 54, which may be configured as a transceiver for transmitting and/or receiving data. The data processing assembly 52 may additionally include an electronics board in the form of a temperature sensing element 56, which may be configured as a one or more temperature sensors configured to sense one or more temperature values and to generate corresponding temperature data. The data processing assembly 52 may additionally include an electronics board in the form of vibration sensing element 58, which may be configured as an accelerometer configured to sense accelerations (i.e., rate of change of velocity) and to generate corresponding vibration data. Furthermore, the data processing assembly 52 may include an electronics board in the form of a processing element 59, which may be configured as an electrical processor or microprocessor configured to process various types of data for the sensor module 10.

Beginning with the processing element 59, the processing element 59 may comprise one or more processors, microprocessors, microcontrollers, field programmable gate arrays (FPGAs), and the like, or combinations thereof. The processing element 59 may comprise dedicated circuitry or logic that is permanently configured, such as an application-specific integrated circuit (ASIC), or indefinitely configured, such as an FPGA, to perform certain operations. The processing element may also comprise programmable logic or circuitry that is temporarily configured by software to perform certain operations. In addition, the electronics board of the processing element 59 may include or be associated with one or more memory elements or internal levels of cache. The memory elements may also be known as a “computer-readable storage medium” and may include random access memory (RAM), read only memory (ROM), flash drive memory, hard disk drives, and the like, or combinations thereof. In some embodiments, the processing element 59 may include a computer program, such as may be stored on the memory elements. The processing element 59 may be capable of executing the computer program, which is also generally known as instructions, commands, software code, executables, applications, apps, and the like, to perform various portions of the functions and features described herein.

In general, the processing element 59 is configured to receive, process, and/or transmit data to/from the remaining components of the data processing assembly 52. For example, the processing element 59 may be in data communication with each of the communication element 54, the temperature sensing element 56, and the vibration sensing element 58. Thus, the processing element 59 will be configured to obtain sensor data from the temperature sensing element 56 and the vibration sensing element 58 and to provide such sensor data to the communications element 54. In some embodiments, the processing element 59 will be configured to process and/or format the sensor data before provisioning the sensor data to the communications element 54. As will be described in more detail below, the communications element 54 will be configured to transmit the sensor data to the gateway 16, in some embodiments wirelessly, via the local network 18.

The temperature sensing element 56 may include an internal temperature sensor for measuring a temperature within the sensor module 10 (e.g., within the interior space presented by the housing 32 of the sensor module 10). For example, the internal temperature sensor may comprise a negative temperature coefficient (NTC) thermistor, a resistance temperature detector (RTD) element, or a thermocouple. Alternatively, the internal temperature sensor may be a semiconductor-based temperature sensor configured on an integrated circuit within the electronics board of the temperature sensing element 56. In some embodiments, the temperature sensing element 56 may additionally include, or otherwise be associated with, a multimeter or voltmeter for measuring resistance, voltage, or other necessary characteristics generated by the internal temperature sensor so as to obtain temperature data therefrom. In some additional embodiments, the temperature sensing element 56 may further include an external temperature sensor for measuring a temperature external to the sensor module 10. For instance, the electronics board of the temperature sensing element 56 may include a port to which the external temperature sensor can be connected. In some embodiments, the external temperature sensor may be in the form of a Type-T thermocouple 60, as illustrated in FIG. 4, which is configured to be releasably connected to the port of the electronics board of the temperature sensing element 56. In such embodiments, the external temperature sensor can be used to measure a temperature value near or far from the sensor module 10 (with the distance being dependent on the length of the thermocouple 60). In such embodiments, the multimeter or voltmeter of the temperature sensing element 56 may be used to measure the voltage (or other necessary characteristics) from the thermocouple 60 so as to generate temperature data therefrom. In some embodiments, the internal and external temperature sensors may be particularly configured to measure temperature values between “−200” and “+200” degrees Celsius.

Turning to the vibration sensing element 58, the vibration sensing element 58 may comprise generally any type of accelerometer configured to measure accelerations (i.e., changes in velocity) and/or vibrations. The accelerometer may be integrated within the electronics board (e.g., as part of an integrated circuit) and may be in the form of a potentiometric accelerometer, a capacitive accelerometer, a piezoelectric accelerometer, a piezo-resistive accelerometer, a variable inductance accelerometer, a Hall Effect accelerometer, a magneto-resistive accelerometer, a fiber Bragg grating (FBG) accelerometer, a heated gas accelerometer, a micro-electro-mechanical system (MEMS) accelerometer, or combinations thereof. In some specific embodiments, the vibration sensing element 58 will include a three-axis accelerometer configured to sense accelerations of up to a peak value of plus/minus 20 g within a 10-4,000 Hz bandwidth. In some embodiments, the accelerometer will be configured to sense accelerations for only two of its three axes.

In some aspects of the present invention, the sensor module 10 may include alternative and/or additional of sensors than those discussed above. For example, in some embodiments, the sensor modules 10 may include humidity sensors, light sensors, wind sensors, etc. Additionally, the sensor module 10 may include sensors for measuring information related to certain operational characteristics of the piece of equipment (e.g., the motor 12) to which the sensor module 10 is attached, such as voltage, current, torque, etc.

The communications element 54 may include signal or data transmitting and receiving circuits, such as antennas, amplifiers, filters, mixers, oscillators, digital signal processors (DSPs), and the like. Thus, the communications element 54 may formed as an integrated circuit within the associated electronics board. The communications element 54 may, in some embodiments, include a microcontroller and/or microprocessor for processing and formatting data before such data is transmitted. The communication element 54 may establish communication wirelessly by utilizing radio-frequency (RF) signals and/or data that comply with communication standards such as cellular 2G, 3G, or 4G, IEEE 802.15.4 (compliant 2.4 GHz), IEEE 802.11 standard (such as WiFi), IEEE 802.16 standard (such as WiMAX), Bluetooth™, or combinations thereof. In some embodiments, the communications element 54 may be configured to transmit data via the Subnetwork Access Protocol (SNAP). In some embodiments, the data transmitted by the communication element 54 may initially be encrypted (e.g., via the processing element 59 and/or the communication element 54) and then transmitted via the SNAP protocol. The communications element 54 may, in some embodiments, include or be associated with a rotatable antenna 62, as illustrated in FIGS. 1, 2, and 4 which extends externally from the housing 32 of the sensor module 10 and permits transmission of data omni directionally from the sensor module 10. Alternatively, or additionally, the communication element 54 may establish communication through physical connectors or couplers that receive metal conductor wires or cables which are compatible with networking technologies, such as Ethernet or USB. In certain embodiments, the communication element 54 may also couple with optical fiber cables.

To aid the data processing assembly 52 to fit within the housing 32 of the sensor module 10, certain embodiments provide for the electronics boards associated with each of the communications element 54, the temperature sensing element 56, the vibration sensing element 58, and the processing element 59 to be vertically stacked (although alternative stacking arrangements are permitted according to certain embodiments of the present invention). In more detail, as illustrated in FIGS. 3 and 4, the communications element 54 may be positioned above the temperature sensing element 56. The temperature sensing element 56 may be positioned above the processing element 59. And the processing element 59 may be positioned above the vibration sensing element 58, such that the vibration sensing element 58 is positioned at or adjacent to the bottom of the data processing assembly 52. Each of the electronics boards of the data processing assembly 52 (i.e., associated with the communications element 54, the temperature sensing element 56, the vibration sensing element 58, and the processing element 59) may, in some embodiments, be secured together (e.g., in vertical relationship) via connection elements, such as rigid support elements or brackets. However, in some embodiments, the vibration sensing element 58 may be secured below the processing element 59 via one or more tension springs 63, as shown in FIG. 4, which function to force the vibration sensing element 58 in a downward direction away from the processing element 59. As will be described in more detail below, such a downward force imparted by the springs 63 may ensure a rigid contact between the vibration sensing element 58 and the base 34 of the sensor module 10, such that the vibration sensing element 58 can be configured to accurately measure vibrations originating from a piece of equipment to which the sensor module 10 is connected.

Furthermore, each of the of the electronics boards of the data processing assembly 52 (i.e., associated with the communications element 54, the temperature sensing element 56, the vibration sensing element 58, and the processing element 59) may be in data communication with each other via electrical wiring, so as to permit communication between each of the communications element 54, the temperature sensing element 56, the vibration sensing element 58, and the processing element 59. In some embodiments, one or more flexible printed circuit board (PCB) elements 64, as shown in FIG. 3, may be used between adjacent electronics boards to facilitate data communication between the communications element 54, the temperature sensing element 56, the vibration sensing element 58, and the processing element 59. In some embodiments, each of the electronics boards of the data processing assembly 54 may be formed from flexible PCB elements.

With reference to FIG. 4, the data processing assembly 52 may additionally include a pair of electrical connectors 66, as shown in FIG. 4, extending upward for connection with a power source of the sensor module 10 (with the power source described in more detail below). For example, in some embodiments, the pair of electrical connectors 66 may extend upward from the electrical board of the temperature sensing element 56. As such, the electrical connectors 66 are configured to make electrical contact with the power source of the sensor module 10 (as described in more detail below) so as to provide electrical power to the data processing assembly 52.

As will be described in more detail, the data processing assembly 52 is configured to be secured within the housing 32 of the sensor module 10. In particular, at least one of the electronics boards of the data processing assembly 52 will be configured to be mounted to the flanged mating surface 39 presented on the upper end of the base 34 (See, e.g., FIG. 4). In some embodiments, fasteners (e.g., screws) may extend downward through the electronics board and the sidewall of the base 34 to secure the data processing assembly 52 to the base 34. In some specific embodiments, the electronics board associated with the temperature sensing element 56 may be sized with a diameter sufficient to be engaged with the mating surface 39 of the base 34, as is shown in FIG. 3. By having the electronics board associated with the temperature sensing element 56 secured to the base 34, and particularly in embodiments in which the base 34 is formed from a heat-conductive material (e.g., aluminum), the sensor module 10 will be configured to efficiently conduct heat from the piece of equipment to which the sensor module 10 is attached, through the base 34, and to the temperature sensing element 56. Stated differently, the temperature sensing element 56 may be thermodynamically coupled with the base 34 and/or with the exterior surface of the piece of equipment. For instance, the base 34 may be in contact with both the temperature sensing element 56 and the piece of equipment so as to directly conduct heat between (e.g., to or from) the temperature sensing element 56 and the piece of equipment As such, the internal temperature sensor of the temperature sensing element 56 may be configured to obtain temperature data that is generally indicative of the temperature of the surface of the piece of equipment.

In such a configuration (i.e., with the electronics board of the temperature sensing element 56 engaged with the flanged mating surface 39 of the base 34), the communications element 54 will extend upwards from the temperature sensing element 56 and above the base 34. Nevertheless, as will be described in more detail below, once the cap 36 is secured on the base 34, the communications element 54 will be enclosed within the interior space of the housing 32 of the sensor module 10, and in particular, within an interior space presented by the cap 36.

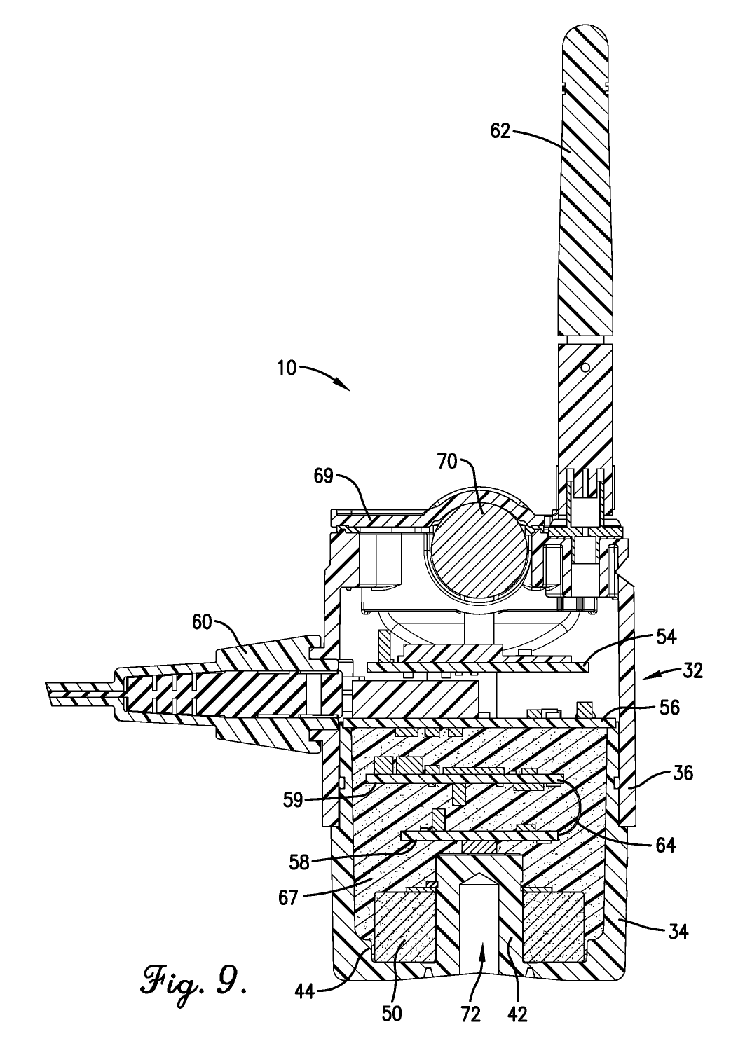

With the data processing assembly 52 secured to the base 34 in the manner described in the preceding paragraphs, the processing element 59 and the vibration sensing element 58 will extend downward from the temperature sensing element 56, such that the processing element 59 and the vibration sensing element 58 are enclosed within the interior space presented by the base 34. As shown in FIG. 3, in some embodiments, the data processing assembly 52 will be secured to the base such that the vibration sensing element 58 makes rigid contact with the post 42 that extends upward from the bottom panel of the base 34. Such rigid contact between the vibration sensing element 58 and the base 34 will ensure that vibrations experienced by the sensor module 34 and/or the piece of equipment to which the sensor module 10 is mounted, can be accurately measured by the vibration sensing element 58. To ensure that the vibration sensing element 58 maintains contact with the post 42, the springs 63 (shown in FIG. 4) connecting the vibration sensing module 58 to the processing element 59 may function to force the vibration sensing element 58 downward into rigid contact with the post 42. In further embodiments, as illustrated in FIG. 9, potting material 67 may be added to the interior space presented by the base 34, so as to aid in securing the data processing assembly 52 in place. Specifically, the potting material 67 may function to hold the data processing assembly 52 in place such that the vibration sensing element 58 maintains rigid contact with the post 42. The potting material 67 may further aid in transferring vibrations from the base 34 to the vibration sensing element 58. Furthermore, such potting material 67 may function to hold the magnet 50 in place within the magnet-receiving trough 48 at the bottom of the base 34. Furthermore still, such potting material 67 may also function to seal those portions of the data processing assembly 52 covered by the potting material 67. The potting material 67 may consist of generally any type of potting material that can be used with electronic components, such as a polyurethane or silicone.

Turning now to the cap 36 of the sensor module 10, as illustrated in FIG. 3, the cap 36 may include the cylindrically-shaped sidewall extending downward from the top panel, as was previously described. In some embodiments, the cap 36 may be formed from plastic. The cap 36 may be secured to the base 34 by the sidewall of the cap 36 extending around the upper portion of the sidewall of the base 34 in a sleeve-like manner, as was previously noted. In such a configuration, i.e., with the cap 36 secured on to the base 34, a portion of the data processing assembly 52 will be positioned within the interior space presented by the cap 36. Specifically, with reference to FIG. 3, the communications element 54 and at least a portion of the temperature sensing element 56 may be positioned within the interior space of the cap 36. As was described previously, in some embodiments, the temperature sensing element 56 may include a port for connection with the external temperature sensor (e.g., the thermocouple 60). To facilitate such connection, in some embodiments, the cap 36 may include an opening, in the form of a window 68 (See, e.g., FIG. 4), extending through a portion of the sidewall of the cap 36. As such, the external temperature sensor may extend from outside the sensor module 10, through the window 68 in the cap 36, and into connection with the temperature sensing element 56. When the external temperature sensor is not in use, a cover may be positioned over the window 68 so as to seal the interior space of the sensor module 10 from the environment.

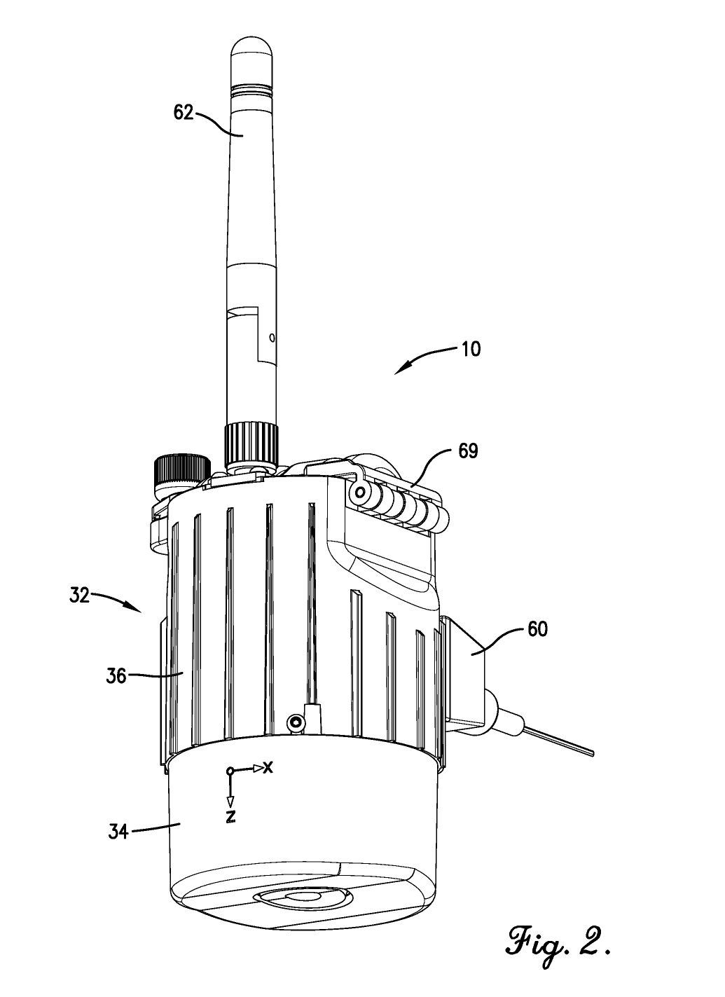

As was noted previously, in some embodiments, the sensor module 10 may include an antenna 62 for improving data transmission and/or receiving capabilities of the communications element 54. As shown in FIGS. 1 and 2, in some embodiments, the antenna 62 may extend upward from the top panel of the cap 36. The antenna 62 may be electrically connected with the communications element 54, such as via electrical wiring, cabling, or the like. In some embodiments, the top panel of the cap may include a connector element to which the antenna 62 may be readily secured to and removed from the cap 36. In some embodiments, the connector element may be in the form of a SubMiniature version A (SMA) connector that to which the antenna 62 can be threadedly secured and unsecured.

Finally, the top panel of the cap 36 may be formed with an opening for receiving an electrical power source, as will be discussed in more detail below. In some embodiments, access to the opening may be provided through a lid 69, as shown in FIGS. 1 and 4, which is hingedly secured to the sidewall and/or to the top panel of the cap 36. The lid 69 may include a threaded fastener for securely locking the lid 69 in place with respect to the top panel of the cap 36. The threaded faster of the lid 69 may be configured to extend through the lid 69 and into a threaded opening formed in the top panel of the cap 36. In some embodiments, a gasket may be incorporated within a bottom side of the lid 69, such that when the lid 69 is in the closed position, the interior space of the sensor module 10 can be sealed from the external environment.

Turning to the opening of the top panel of the cap 36 in more detail, as shown in FIGS. 3 and 4, the opening may be formed in the top panel with a shape configured to receive an electrical power source, such as a battery 70. In some embodiments, the battery 70 may comprise a replaceable 3 Volt CR123 battery. However, in other embodiments, the battery 70 may be rechargeable and/or may be formed with a different size and capacity. As was described previously, the data processing assembly 52 may include the pair of electrical connectors 66 (See FIG. 4) extending upward from the communications element 54. In such embodiments, the electrical connectors 66 may extend upward into the opening of the top panel of the cap 36, with one electrical connector 66 positioned on either end of the opening. As such, the electrical connectors 66 are positioned so as to make contact with electrical contacts on ends of the battery 70. In such a configuration, the battery 70 can provide electrical power to the data processing assembly 52 via the electrical connectors 66. In some embodiments, the data processing assembly 52 can measure, via the electrical connection made by the electrical connectors 66, various characteristics about the battery 70, such as voltage level. In some embodiments, the multimeter or voltmeter associated with the temperature sensing element 56 may be used to measure the voltage of the battery 70, as necessary. Alternatively, the data processing assembly 52 may include other sensors for measuring battery characteristics from the battery 70. Nevertheless, in some embodiments, the data processing assembly 52 may be configured to generate battery data related to battery characteristics (e.g., voltage) of the battery 70. Such battery data may, in some embodiments, be included as part of the sensor data generated by the sensor module 10.

In operation, one or more sensor modules 10 can be secured to a piece of equipment to monitor vibrations and temperatures related to the piece of equipment. For example, as illustrated in FIG. 5, one sensor module 10 is secured to the motor 12 to obtain vibration data and temperature data for the motor 12. Although the sensor module 10 is illustrated being secured to a bottom of the motor 12, the sensor module 10 may be secured elsewhere on the motor 12. The sensor module 10 may be securely held in place on the motor 12 via a magnetic force imparted by the magnet 50, which as described above, is housed within the interior space of the housing 32 of the sensor module 10. Specifically, the magnet 50 may be housed within the interior space presented by the base 34 and may be positioned adjacent to the bottom panel of the base 34. Thus, the sensor module 10 may be securely attached to motor 12 by positioning an exterior surface of the bottom panel of the base 34 against an exterior surface of the motor 12. In such a position, the magnetic force from the magnet 50 will interact with the metal of the motor 12 to securely hold the sensor module 10 in place against the motor 12. It should be understood that the magnetic force provided by the magnet 50 should be sufficient to hold the sensor module 10 in place even during operation of the motor (or other piece of equipment), which may cause significant vibrations. In some embodiments, the magnet 50 may be configured to generate at least a 25 lb. force. Beneficially, in embodiments in which the base 34 of the sensor module 10 is formed from aluminum (i.e., a paramagnetic material), the base 34 will provide a solid and durable surface for mating with the motor 12, while not interfering with the magnetic field generated by the magnet 50.

In alternate embodiments, the sensor module 10 may be secured in place on the piece of equipment (e.g., the motor from FIG. 5) by the mounting assembly comprising one or more mechanical fasteners. For example, as illustrated in FIG. 3, the sensor module 10 may include a threaded opening 72 formed through the bottom panel and at least a portion of the centrally-positioned post 42 that extends upward from the bottom panel of the base 34. As such, if the motor 12 includes a threaded shaft extending exteriorly from the motor 12, the sensor module 10 may be threaded on to the threaded shaft by engaging the threaded shaft (e.g., via rotation) within the threaded opening 72.

Regardless, with the sensor module 10 securely held in place in engagement with the motor 12 (or other piece of equipment), the sensor module 10, as described above, is configured to obtain various types of sensor data related to the motor 12 and to transmit such data to the gateway 16. In particular, the sensor module 10 is configured to obtain vibration data indicative of the vibrations experienced by the motor 12. Such vibration data may be obtained by the vibration sensing element 58 of the sensor module 10. With the sensor module 10 secured to the motor 12, any vibration experienced by the motor 12 will be imparted to the sensor module 10. Specifically, any such vibration will be imparted to the bottom panel of the base 34, to the post 42 extending upward from the bottom panel of the base 34, and to the vibration sensing element 58 in contact with the post 42. Thus, the sensor module 10 is configured to obtain sensor data indicative of the vibrations being experienced by the motor 12.

In addition, the sensor module 10 may be configured to obtain temperature data indicative of a temperature at or near the surface of the motor 12, as well as a temperature external to the motor 12. For example, the internal temperature sensor of the temperature sensing element 56 may obtain temperature data indicative of the temperature at the surface of the motor 12. Specifically, as was noted previously, in some embodiments, the data processing assembly 52 will be positioned within the interior space of the sensor module 10 in a manner that permits the temperature sensing element 56 to be in contact with the base 34, as was previously described. Furthermore, the base 34 will, in some embodiments, be formed from a heat-conductive material, such as aluminum. As such, when the sensor module 10 is secured to the motor 12 with the bottom panel of the base 34 in contact with the surface of the piece of equipment, heat generated by the motor 12 can pass through the base 34 and to the temperature sensing element 56. The internal temperature sensor the temperature sensing element 56 can, therefore, accurately measure a surface temperature of the motor 12 even while the temperature sensing element 56 is positioned within the interior space of the sensor module 10. It should be further understood, however, that in some embodiments, the internal temperature sensor may not be configured to exactly measure the temperature of the motor 12. Nevertheless, the internal temperature sensor is generally configured to recognize temperature variations associated with corresponding temperature variations with the motor 12. Such variations may be sufficient to determine problems with the motor 12.

In addition, the external temperature sensor of the temperature sensing element 56 can be used to obtain temperature data indicative of a temperature external to the motor 12. As was noted previously, in some embodiments, the external temperature sensor may comprise a thermocouple 60 that can be extended from the housing 32 of the sensor module 10 to generally any given location spaced apart from the motor 12. As such, the external temperature sensor of the temperature sensing element 56 can obtain temperature data indicative of the external temperature at the given location. In some instances, the motor 12 (or other piece of equipment) may be associated with a piece of machinery (not shown). For example, the motor 12 may provide rotary power to a piece of machinery. In some embodiments, with the sensor module 10 connected to the motor 12, the thermocouple 60 of the sensor module 10 may be extended away from the motor 12 and into contact with the piece of machinery, such that the sensor module 10 can obtain temperature data related to the temperature of the piece of machinery. As a result, embodiments of the present invention provide for the temperature sensing element 56 of the sensor module 10 to obtain temperature data indicative of two temperatures. The first temperature may be a temperature of the surface of the motor 12, while the second temperature may be a temperature external to the motor 12. It should be understood, however, that the thermocouple 60 may, in some embodiments, be optional. For example, in some embodiments, the sensor module 10 may only include an internal temperature sensor. In some alternative, or additional, embodiments, the temperature sensing element 56 may be configured to communicatively couple with an external temperature sensor; however, such external temperature sensor may not necessarily form part of the sensor module 10.

Furthermore, as was noted above, in some embodiments, the data processing assembly 52 may be configured to obtain battery data indicative of battery characteristics (e.g., voltage) of the battery 70 that provides electrical power to the sensor module 10. In some embodiments, such battery data may be included as part of the sensor data obtained by the sensor module 10.

Furthermore still, as discussed previously, in some aspects of the present invention, the sensor module 10 may include alternative and/or additional of sensors than those discussed above. For example, in some embodiments, the sensor modules 10 may include humidity sensors, light sensors, wind sensors, etc. Additionally, the sensor module 10 may include sensors for measuring information related to certain operational characteristics of the piece of equipment (e.g., the motor 12) to which the sensor module 10 is attached, such as voltage, current, torque, etc. Any data generated by such alternative and/or additional sensors may, in some embodiments, be included as part of the sensor data.

Upon the sensor module 10 obtaining vibration data, temperature data, and/or battery data (collectively, sensor data), the sensor module 10 may perform initial processing and/or storage of the sensor data. In particular, the temperature sensing element 56 may transmit temperature data to the processing element 59, and the vibration sensing element 58 may transmit vibration data to the processing element 59. In addition, battery data may also be transmitted to the processing element 59. Once such sensor data is received, the processing element 59 may format the sensor data for transmission to the gateway 16. In particular, the processing element 59 may be configured to format the sensor data according to a SNAP protocol format, such that the communications element 54 can transmit the data to the gateway 16 over the local network 18. SNAP is a protocol for transmitting IP datagrams across IEEE 802 networks. In general, IP datagrams are digital messages sent over such networks. IP datagrams will comprise a header, which includes, inter alia, information related to the source/sender of the message, the destination/recipient of the message, a message identifier, and/or a timestamp. In addition to the header, the IP datagrams will also include a payload, which comprises the relevant message data (i.e., the sensor data) intended to be transmitted from the source to the destination. As used herein, the term “data packet” will be used to reference an IP datagram.

In view of the above, the processing element 59 may process the sensor data into a data packet formatted according to the SNAP protocol. In some embodiments, the sensor data may also be encrypted (e.g., by the processing element 59 and/or the communication element 54) when configured into the data packet. During such processing, some sensor data and/or data packets may, at least temporarily, be stored in memory elements associated with the processing element 59. Upon processing and/or formatting the sensor data into a data packet, the data packet may be provided to the communications element 54 for transmission to the gateway 16 via the local network 18. Although the above description illustrates how the processing element 59 can process and/or format the sensor data into a data packet, it should be understood that in some embodiments, the processing element 59 may provide the sensor data directly to the communication element 54, and the communication element 54 may process and/or format the sensor data into a data packet according the SNAP protocol for transmission to the gateway 16 via the local network 18.

Embodiments provide for the sensor module 10 to obtain sensor data (e.g., temperature data, vibration data, and/or battery data) according to generally any measurement interval. For example, the sensor module 10 may be configured to obtain sensor data once every second, once every minute, once every hour, etc. The configuration of the measurement interval may be established by programming the sensor module 10 via the processing element 59, which can instruct the temperature sensing element 56 and the vibration sensing element 58 when to obtain sensor data. For each set of sensor data obtained by the sensor module 10 for a given measurement interval, the sensor module 10 can create a data packet that includes sensor data representative of the set of sensor data. Alternatively, the processing element 59 may send the sensor data to the communication element 54, and the communication element 59 may process and/or format the sensor data into a data packet. Regardless, as was noted previously, such a data packet may be configured according to the SNAP protocol. As such, the data packet will comprise a header portion that defines the source (i.e., the sensor module 10), the destination (i.e., the gateway 16), the message identifier, and/or the timestamp. The data packet will additionally comprise a payload that includes sensor data for the given measurement interval. As was noted previously, in some embodiments, the sensor data within the data packet may be encrypted (e.g., via the processing element 59 and/or the communication element 54).

The message identifier for a given data packet may be used to identify the given data packet. For example, the message identifier may be in the form of a counter that increases in magnitude for each successive data packet generated/transmitted. For example, if the measurement interval is one minute, the sensor module 10 may obtain a first set of sensor data (i.e., representative of the temperature data, the vibration data, and/or the battery data obtained for the initial measurement interval). The resulting data packet will include a message identifier that identifies the data packet as being the initial data packet. For example, the message identifier may be “0001.” After one minute has elapsed, the sensor module 10 obtains a second set of sensor data (i.e., representative of the temperature data, the vibration data, and/or the battery data obtained for the second measurement interval). The sensor module 10 may generate a resultant data packet with a message identifier that identifies the data packet as the second data packet. For example, the message identifier may be “0002.” As will be discussed in more detail below, the use of message identifiers may aid the gateway 16 in processing the data packets received from the sensor module 10. Efficient processing of the data packets can enhance longevity of the sensor module 10, including the operational life of the battery 70.

Upon the generation of a data packet (each including temperature data, vibration data, and/or battery data for a given measurement interval), the sensor module 10 will be configured to transmit, via the communication element 54, such data packet to the gateway 16 via the local network 18 for further processing. In some embodiments, the sensor module 10 will transmit each data packet immediately, in real-time upon creation of the data packet. In such embodiments, the transmission rate of the sensor modules 10 will be generally equal to the measurement interval. Alternatively, in some embodiments, the sensor module 10 may aggregate the data packets over a period of time into a batch of data packets and transmit the batch of data packets to the gateway 16 over the local network 18. In addition, in some embodiments, the sensor module 10 will be configured to store each data packet and/or each set of sensor data (i.e., for each temperature measurement, vibration measurement, and/or battery measurement obtained for a given measurement interval) for a predetermined period of time. For example, in some embodiments, the sensor module 10 may store, at least temporarily, the data packets collected over a period of measurement intervals. Such storage capabilities may be beneficial for instances in which transmission problems occur, and/or when the sensor module 10 becomes disconnected from the local network 18.

The above description provides an illustration for how a single sensor module 10 can be connected to a piece of equipment (e.g., the motor 12), can obtain sensor data related to the piece of equipment, and can transmit such sensor data to the gateway 16 over the local network 18. However, as illustrated in FIG. 6, embodiments of the present invention may include the SM System 14, which can include a plurality of sensor modules 10 in communication with the gateway 16 over the local network 18. Each of such plurality of sensor modules 10 may be connected to an individual piece of equipment (e.g., a motor similar to the motor 12), may collect sensor data related to its respective piece of equipment, and may transmit such sensor data to the gateway 16 over the local network 18. Such a SM System 14 may be used, for instance, within a manufacturing facility, in which a plurality of pieces of equipment (e.g., a plurality of motors 12) are used in a manufacturing process. Beneficially, the sensor modules 10 may be used to monitor the pieces of equipment and to transmit resulting sensor data for further analysis. In some embodiments, multiple sensor modules 10 may be secured to an individual piece of equipment so as to obtain additional sensor data related to the piece of equipment and/or for redundancy in case one or more sensor modules 10 experiences a malfunction, loses power, otherwise fails, and/or becomes disconnected from the local network 18.

As discussed earlier, in some preferred embodiments, the local network 18 of the SM System 14 may be local area network (LAN) to which each of the sensor modules 10 and the gateway 16 are connected. For example, the local network 18 may be configured according to IEEE 802.15.4 (compliant 2.4 GHz) and/or IEEE 802.11 standard (such as WiFi). Beneficially, in some such embodiments, the local network 18 may be configured as a mesh network. Alternatively, the local network 18 may comprise a metro or wide area networks such as the Internet or other cloud networks. The local network 18 may preferably be wireless, but may, in some embodiments be wired. The local network 18 may include one or more servers, routers, switches, wireless receivers and transmitters, and the like, as well as electrically conductive cables or optical cables. Furthermore, the local network 18 may include cellular or mobile phone networks, as well as landline phone networks, public switched telephone networks, fiber optic networks, or the like.

The gateway 16 may be configured to receive the data packets from each of the sensor modules 10 of the SM System 14, via the local network 18, and subsequently re-transmit the resulting sensor data to the server device 20 over the wide network 22. As such, the gateway 16 may be configured to receive and process data packets from each of the sensor modules 10, and to provide resulting sensor data (as generated by the plurality of sensor modules 10) to the server device 20 over the wide network 22 for further processing. The gateway 16 may comprise generally any type of computing device with one or more processing elements, one or more memory elements, and one or more communication elements, which permit the gateway 16 to function as an intermediary so as to pass sensor data from the sensor modules 10 (as received over the local network 18) to the server device 20 (over the wide network 22).

In more detail, the gateway 16 may include a processing element in the form of one or more processors, microprocessors, microcontrollers, field programmable gate arrays (FPGAs), and the like, or combinations thereof. The processing element may comprise dedicated circuitry or logic that is permanently configured, such as an application-specific integrated circuit (ASIC), or indefinitely configured, such as an FPGA, to perform certain operations. The processing element may also comprise programmable logic or circuitry that is temporarily configured by software to perform certain operations. In addition, the gateway 16 may include or be associated with one or more memory elements or internal levels of cache. The memory elements may also be known as a “computer-readable storage medium” and may include random access memory (RAM), read only memory (ROM), flash drive memory, hard disk drives, and the like, or combinations thereof. In some embodiments, the gateway 16 may be software defined, such as a computer program configured to perform the above-described tasks, e.g., similar to a default gateway or a router.

The gateway's 16 communication element may include signal or data transmitting and receiving circuits, such as antennas, amplifiers, filters, mixers, oscillators, digital signal processors (DSPs), and the like. The communication element of the gateway 16 may establish communication wirelessly by utilizing radio-frequency (RF) signals and/or data that comply with communication standards such as cellular 2G, 3G, or 4G, IEEE 802.15.4 (compliant 2.4 GHz), IEEE 802.11 standard (such as WiFi), IEEE 802.16 standard (such as WiMAX), Bluetooth™, or combinations thereof. In some embodiments, the communication element gateway 16 may be configured to receive, process, and/or transmit data via SNAP protocol. Alternatively, or additionally, the communication element of the gateway 16 may establish communication through connectors or couplers (e.g., Ethernet or USB) that receive metal conductor wires or cables which are compatible with networking technologies. In certain embodiments, the communication element of the gateway 16 may also couple with optical fiber cables.

In operation, the gateway 16 will be configured to receive each of the data packets transmitted by each of the sensor modules 10 included in the SM System 14. For example, the SM System 14 may include three sensor modules 10, with each sensor module 10 being secured to an individual piece of equipment (e.g., a motor similar to the motor 12 of FIG. 5). Thus, each sensor module 10 can obtain temperature data and vibration data for its respective piece of equipment, and also battery data for its respective battery 70, and transmit such sensor data as part of a data packet to the gateway 16 over the local network 18. Beneficially, the gateway 16 is configured to process and monitor the data packets to ensure that all necessary data packets have been received. As was noted above, each of the data packets includes a message identifier, which identifies the data packet. The gateway 16 is configured to monitor each of the received data packets to determine if any data packets are not received. For instance, by analyzing the message identifier for each data packet, the gateway 16 can determine if any data packet for a given sensor module 10 is missing. If a data packet is missing, the gateway 16 can communicate with the given sensor module 10 to request re-transmission of such missing data packet. In some embodiments, the gateway 16 may only request for the given sensor module 10 to re-transmit the missing data packet a predetermined number of times (e.g., five times, ten times, fifteen times, etc.). Alternatively, the gateway 16 may only request for the given sensor module 10 to re-transmit the missing data packet for a predetermined period of time (e.g., for five minutes, for one hour, for 1 day, etc.). Such functionality is beneficial in that the sensor modules 10 are not constantly being asked to re-transmit data packets and are only asked to re-transmit those individual, missing data packets, which helps to preserve battery life for the batteries 70 of the sensor modules 10. In addition, by only requesting that the sensor modules 10 re-transmit missing data packets for a predetermined period of time, the data storage requirements of the sensor modules 10 can be minimized.

The gateway 16 will be configured to collect the data packets from each of the sensor modules 10 in the SM System 14 and to transmit the resulting sensor data from the sensor module 10 to the server device 20 over the wide network 22. In some embodiments, the gateway 16 may process and/or format the sensor data within the data packets to a protocol other than SNAP for transmission to the server device 20. For example, the gateway 16 may collect the sensor data received from each of the sensor modules 10 and process and/or re-format such data into a batch for transmission to the server device 20. In some embodiments, the gateway 16 may transmit the resulting sensor data generally in real time. For example, as soon as the data packets are received, the gateway 16 may process and/or re-format the sensor data and immediately, in real-time transmit such data, over the wide network 22, to the server device 20. Alternatively, the gateway 16 may be configured to transmit sensor data to the server device 20 periodically (e.g., once per minute, once per hour, once per day, etc.), or in various other timing arrangements. In some embodiments, the gateway 16 may be configured to store the sensor data for a period of time. For example, if the gateway 16 becomes disconnected from the wide network 22, the gateway 16 may store the sensor data until connection to the wide network 22 has been restored. Finally, in some embodiments, the sensor data may be encrypted by the gateway 16, such that the sensor data can be transmitted to the server device 20 in an encrypted format.

As discussed earlier, in some preferred embodiments, the wide network 22 may be a wide area network (WAN), such as the Internet or other cloud-based network. The communications network 22 may wired or wireless, and may include one or more servers, routers, switches, wireless receivers and transmitters, and the like, as well as electrically conductive cables or optical cables. Furthermore, the wide network 22 may include cellular or mobile phone networks, as well as landline phone networks, public switched telephone networks, fiber optic networks, or the like.

The server device 20 may include one or more computing devices that provide access to one or more general computing resources, such as Internet services, data transfer services, data storage services, and the like. The server device 20 may also provide access to a database that stores information related to the SM System 14 of the present inventive concept. The database may also store other information and data necessary for the implementation of the computer program and method of embodiments of the present invention. For example, the sensor data obtained from the gateway 16 may be stored on the server device 20 for further analysis, as will be discussed in more detail below. In general, the server device 20 may include a computer program configured to implement one or more functions and features described herein. Such computer program may be executed on the server device 20 and/or accessed by a user's computing device (e.g., a desktop, a mobile device, etc.), as will be discussed in more detail below.

In general, the server device 20 may include any device, component, or equipment with a processing element and associated memory elements. The processing element may implement operating systems, and may be capable of executing the computer program, which is also generally known as instructions, commands, software code, executables, applications, apps, and the like. The processing element may include processors, microprocessors, microcontrollers, field programmable gate arrays, and the like, or combinations thereof. The memory elements may be capable of storing or retaining the computer program and may also store data, typically binary data, including text, databases, graphics, audio, video, combinations thereof, and the like. The memory elements may also be known as a “computer-readable storage medium” and may include random access memory (RAM), read only memory (ROM), flash drive memory, floppy disks, hard disk drives, optical storage media such as compact discs (CDs or CDROMs), digital video disc (DVD), Blu-Ray™, and the like, or combinations thereof. In addition to these memory elements, the server device 20 may further include file stores comprising a plurality of hard disk drives, network attached storage, or a separate storage network.

In certain embodiments of the present invention, the computer program may be stored on the server device 20 in a manner that permits a user to access the computer program as an electronic resource, such as a mobile “app” or website. For the web-accessible computer program, the user may simply access the computer program on the server device 20 over a general network (e.g., the Internet) with the user's computing device (e.g., a personal computer, a mobile device, etc.). Alternatively, one or more portions of the computer program may be embodied in a stand-alone program, which can be downloaded on a user's computing device. In such embodiments of the present invention, at least a portion of the computer program may be an “application,” such as an “app” for the user's computing device. After the computer program has been downloaded, the program can be installed on the user's computing device in an executable format. As such, the stand-alone computer program or the web-accessible program provides users with access to the electronic resource from which the users can interact with various embodiments of the present invention, as discussed in more detail below.

In more detail, the electronic resource, as implemented by the computer program running on the server and/or on the user's computing device, permits a user to create a user account. The user account may be associated with a user name and password, which permits the user to access the user account. The user account may be associated with an inventory of one or more sensor modules 10, one or more gateways 16, and/or one or more pieces of equipment (e.g., the equipment to which the sensor modules 10 are connected). For example, the user account may be associated with the three sensor modules 10 and the gateway 16 that form part of the SM System 14 shown in FIG. 6. Nevertheless, it should be understood that the user account may be associated with any number of sensor modules 10, groups of sensor modules 10, gateways 16, and/or pieces of equipment. In some embodiments, the electronic resource may permit the user to group relevant inventory together to analyze relevant information for such groupings of sensor modules 10, gateways 16, and/or pieces of equipment. In addition, the electronic resource may permit the user to identify the location of where each grouping of sensor modules 10, gateways 16, and/or pieces of equipment is located. Such location may be defined by a physical address or may be geo-located virtually via a mapping function.

In view of the above, the electronic resource permits the user to view relevant information for each item in the inventory accessible by the user. For each of the sensor modules 10 associated with the user's user account, the user can access, monitor, and/or analyze the aggregated sensor data for those sensor modules, with such sensor data being aggregated and stored on the database or other memory elements associated with the server device 20 (upon transmission of such sensor data from the gateway 16 over the wide network 22).

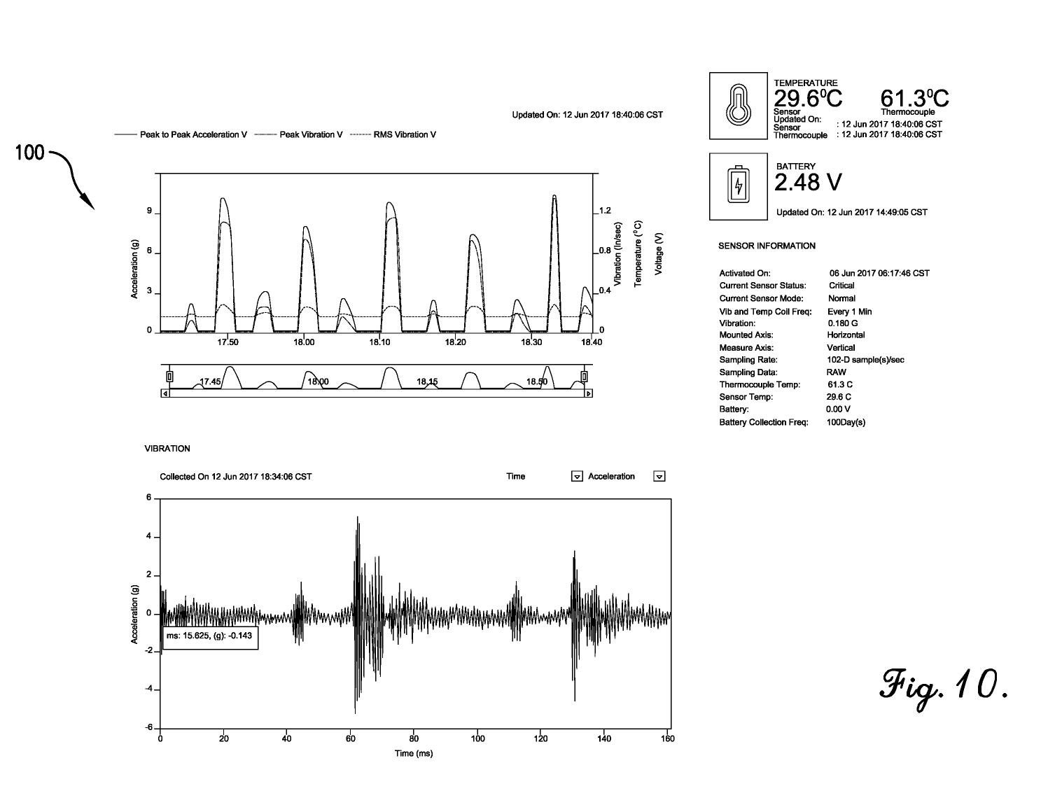

In some embodiments, the electronic resource will permit the user to visualize the sensor data for the one or more sensor modules via one or more dashboards or graphical user interfaces (GUIs), which the computer program may be configured to generate on an electronic display of the user's computing device. For example, FIG. 10 illustrates an exemplary GUI 100 for a given sensor module 10. As shown, the GUI 100 can present one or more graphs that illustrate the sensor data for the given sensor module 10 over time. In general, such sensor data is accessed from the database of the server device 20 by the computer program.

In more detail, a first exemplary graph (i.e., the top graph in GUI 100) presents a compilation of the sensor data over time for the given sensor module 10. In more detail, the first exemplary graph shows vibration data over time. Such vibration data may be shown in units of standard gravity “g,” with such vibration data having been obtained from the vibration sensing element 58 of the sensor module 10. Alternatively, or in addition, the vibration data may be shown in units of “inches per second.” with such vibration data having been obtained from the vibration sensing element 58 of the sensor module. In addition, the first exemplary graph shows temperature data over time. Such temperature data may be obtained by the internal temperature sensor and/or the external temperature sensor of the temperature sensing element 56 of the sensor module 10. It should be understood that the sensor module will generally be mounted to a piece of equipment (e.g., the motor 12 of FIG. 5), such that the vibration data and the temperature data are indicative of the vibrations and temperatures being experienced by the piece of equipment. Furthermore, the first exemplary graph may also show battery data over time, which is indicative of battery 70 characteristics (e.g., voltage) for the sensor module 10. In some embodiments, the time-frame illustrated in the first exemplary graph can be selected, as necessary, to view sensor data further back into history for the sensor module 10.

In addition to the first exemplary graph, which shows a compilation of sensor data over time, the GUI 100 is configured to present the user with a particular subset of the sensor data over time for the given sensor module 10. For example, a second exemplary graph (i.e., the bottom graph in GUI 200) shows vibration data over time, with such vibration data being shown in units of standard gravity “g.” However, a user can select to show any individual type of sensor data within the second exemplary graph.

In addition to the graphs, which display sensor data over time, the GUI 100 may present the instantaneous values of the sensor data for the given sensor module 10. For instance, as show in the upper right-hand corner of the GUI 100, the instantaneous values for the temperature data (both internal temperature and external temperature) for the given sensor module 10 may be shown. The instantaneous battery data, in the form of voltage, for the sensor module's 10 battery 70 may also be shown. In further embodiments, the instantaneous vibration data for the given sensor module 10 may be shown.

As noted previously, the sensor modules 10 may be configured to obtain sensor data at a pre-selected measurement interval. Embodiments of the present invention provide for the user to select such measurement intervals via the electronic resource present by the computer program of the present invention. For example, via the GUI 100 (or another GUI) presented by the electronic resource, the user can select the appropriate measurement interval for each of the one or more sensor modules 10 associated with the user's user account. In some embodiments, the user can select different intervals for each of the sensor modules 10 under the user's control. Furthermore, embodiments may permit the user to select a different measurement interval for each of the different types of sensor data. For example, user may specify that the measurement interval for vibration data and temperature data for a given sensor module 10 is once per minute, while the measurement interval for the battery data for the given sensor module 10 is once per month. Upon establishing the appropriate measurement interval, the server device 20 may send such instructions to the appropriate sensor module 10 via communication with the gateway 16 (over the wide network 22). The gateway 16 can then provide such instructions directly to the appropriate sensor module 10 via the local network 18, such that the sensor module 10 can program its measurement intervals as requested by the user.

The electronic resource may further permit the user to establish alerts for each of the sensor modules 10 associated with the user's user account. Such alerts may provide a notification to the user if any of the sensor data associated with the sensor modules 10 indicates that the sensor module 10 is generating sensor data indicative of an error, a malfunction, and/or a failure. As has been described in more detail above, the sensor modules 10 may each be connected with a piece of equipment, such as motor 12 illustrated in FIG. 5. Thus, an alert may provide an indication that the motor 12 is experiencing an error, a malfunction, and/or a failure. The electronic resource may permit users to create alerts through one of the GUI's presented by the electronic resource. To create an alert, the user may select one or more of the items in the user's inventory (e.g., a sensor module 10 or group of sensor modules) and may generate an alert rule applicable for the selected the inventory items. With respect to sensor modules 10, for example, user may establish an alert rule that activates an alert when any of the sensor data of the sensor modules 10 exceeds or falls below respective maximum or minimum values or ranges of values. An alert rule may alternatively activate an alert when the rate of change of any of the sensor data of the sensor modules 10 exceeds or falls below respective maximum or minimum values or ranges.

For instance, the user may create a first alert for a sensor module 10, with the first alert associated with an alert rule that specifies that the first alert is activated if the sensor module 10 experiences a vibration (as indicated by the vibration data) that exceeds a maximum value. The vibration data exceeding the maximum value may be indicative of the piece of equipment to which the sensor module 10 is attached experiencing a mechanical problem or failure. Thus, if the vibration data exceeds the maximum value, then the first alert is activated. Similarly, the user may establish a second alert for the sensor module 10, with the second alert associated with an alert rule that specifies that the second alert is activated if the if the sensor module 10 experiences a temperature (as indicated by the temperature data) that exceeds a maximum value. The temperature data exceeding the maximum value may be indicative of the piece of equipment to which the sensor module 10 is attached experiencing a mechanical problem or failure. As noted previously, each sensor module 10 may include both an internal temperature sensor and an external temperature sensor. The internal temperature sensor may be indicative of the surface temperature of the piece of equipment (e.g., the motor 12) to which the sensor module 10 is attached, while the external temperature sensor may be indicative of a temperature external to the piece of equipment. For example, the external temperature sensor may be secured to a piece of machinery that is being powered by the piece of equipment to which the sensor module 10 is attached. Thus, the temperature data exceeding the maximum value may be indicative of either the piece of equipment failing, or the piece of machinery being powered by the piece of equipment failing. Furthermore, an alert may be created for vibration data falling below a minimum value and/or for temperature data following below a minimum value. Similarly, an alert may be created for battery data falling below a minimum value, which may indicative of the battery 70 for the sensor module 10 requiring replacement or re-charging.

Upon any of the alerts being activated (e.g., by sensor data exceeding the established maximum or minimum values), embodiments may provide an indication of such alert to the user. Such an indication may be in the form of a visible alert displayed on a GUI generated by the electronic resource. Alternatively, or in addition, an audible alert may also be generated by the electronic resource and emitted by the user's computing device. In further alternatives, alert messages may be generated and sent to the user via email or SMS messaging.

In view of the above, embodiments of the present invention provide for sensor data associated with sensor modules 10 to be visualized and analyzed in real time. Based on analysis of such real-time sensor data, as may be displayed via the GUI 100 and/or as may be used as the basis to generate alerts, embodiments of the present invention provide for users to quickly determine the health of equipment to which the sensor modules 10 are connected. For example, if a user receives an alert that a piece of equipment is on the verge of failing due to a mechanical issue (e.g., as may be indicated by sensor data exceeding or falling below an maximum or minimum values), the user may be able to fix the mechanical issue before such failing occurs. Furthermore, by analyzing the real-time or historical sensor data, users can predict and/or identify maintenance issues that may be outside normal maintenance schedules. Thus, embodiments can aid in reducing downtime of equipment and can minimize any costs associated with such downtime.

Finally, in addition to presenting real-time or historical sensor module 10 sensor data via GUI's, embodiments provide for sensor data to be compiled into various reports for downloading and/or further analysis. Such reports may include data for one or more sensor modules 10, one or more groups of sensor modules 10, one or more gateways 16, one or more pieces of equipment (e.g., to which the sensor modules 10 are connected), one or more locations (e.g., where the sensor modules 10, the gateways 16, and/or the pieces of equipment are located), and/or one or more events (e.g., reports based on historical alerts). For example, all of the historical sensor data for each of the sensor modules 10 associated with the user's user account may be stored in the database of the server device 20 and available for download onto the user's computing device for further analysis. Such reports may be used for data analytics to generate equipment maintenance schedules, to proactively identify future equipment failure issues, and/or to identify patterns in the life of equipment.

Although the invention has been described with reference to the one or more embodiments illustrated in the figures, it is understood that equivalents may be employed and substitutions made herein without departing from the scope of the invention as recited in the claims. For example, although the above description primarily discussed the sensor modules 10 being used with motors 12, it should be understood that the sensor modules 10 may be used with other types of equipment that experiences vibration and temperature variations. Such other types of equipment may include, for example, manufacturing equipment, pumps, compressors, heat exchangers, engines, turbines, vehicles, etc.

Having thus described one or more embodiments of the invention, what is claimed as new and desired to be protected by Letters Patent includes the following:

What is claimed is:

1. A method for monitoring health of equipment, said method comprising the steps of:
securing a plurality of sensor modules on to a plurality of pieces of equipment, wherein each sensor module is secured on to a separate piece of equipment;
generating, by each sensor module, sensor data related to the piece of equipment on to which the sensor module is secured, wherein the sensor data includes vibration data for the piece of equipment, temperature data for the piece of equipment, and temperature data for a location exterior to the piece of equipment;
processing, by each sensor module, the sensor data generated by the sensor module into a data packet, wherein the data packet includes the sensor data;
transmitting the data packet from each sensor module to a gateway over a local communications network; and
transmitting the sensor data from the gateway to a server device.

2. The method of claim 1, wherein the step of processing the sensor data into a data packet includes formatting the sensor data according to a subnetwork access protocol.

3. The method of claim 1, wherein the step of processing the sensor data into a data packet includes encrypting the sensor data.

4. The method of claim 1, further comprising the step of analyzing, by the gateway, the data packets received from the sensor modules to determine if any data packets are missing.

5. The method of claim 4, wherein each data packet includes a message identifier, wherein the step of analyzing the data packets to determine if any data packets are missing includes analyzing the message identifiers of the data packets.

6. The method of claim 4, further comprising the step of upon determining that one or more data packets are missing, requesting, by the gateway, for one or more sensor modules to re-transmit the one or more missing data packets.

7. The method of claim 6, wherein the gateway is configured to only request for the sensor modules to re-transmit the missing data packets for a period of time.

8. The method of claim 1, further including the step of storing the sensor data on a database associated with the server device.

9. The method of claim 8, further including the step of presenting at least a portion of the sensor data stored on the database of the server device as part of a graphical user interface generated on a computing device of a user.

10. The method of claim 1, wherein the step of generating, by each sensor module, sensor data, includes generating battery data for a battery included in the sensor module.

11. The method of claim 1, wherein each piece of equipment comprises a motor.

12. The method of claim 11, wherein the temperature data for the location exterior to the motor comprises temperature data for a piece of machinery powered by the motor.

13. A sensor module system for monitoring health of equipment, said sensor module system comprising:
a plurality of sensor modules, each mounted to a piece of equipment,
wherein each sensor module is configured to generate sensor data relevant to the piece of equipment to which said sensor module is mounted, wherein the sensor data includes vibration data for the piece of equipment, temperature data for the piece of equipment, and temperature data for a location exterior to the piece of equipment;
wherein each sensor module is configured to process the sensor data generated by said sensor module into a data packet that includes the sensor data;
a gateway configured to receive the data packets from each of said sensor modules; and
a server device configured to receive, from said gateway, the sensor data for each sensor module.

14. The sensor module system of claim 13, wherein said sensor modules are configured to process the sensor data into data packets formatted according to a subnetwork access protocol.

15. The sensor module system of claim 13, wherein said sensor modules are configured to encrypt the sensor data.

16. The sensor module system of claim 13, wherein said gateway is configured to analyze the data packets received from said sensor modules to determine if any data packets are missing.

17. The sensor module system of claim 16, wherein each data packet includes a message identifier, wherein said gateway is configured to analyze the message identifiers of the data packets to determine if any data packets are missing.

18. The sensor module system of claim 13, wherein said server device includes a non-transitory computer readable storage medium with a computer program stored thereon, wherein the computer program is configured to instruct a processor to perform the following step: generate a graphical user interface that displays at least a portion of the sensor data.

19. The sensor module system of claim 18, wherein the computer program is further configured to instruct the processor to perform the following step: present, via the graphical user interface, the sensor data in a chart, wherein the chart illustrates the sensor data with respect to time.

20. The sensor module system of claim 18, wherein the computer program is further configured to instruct the processor to perform the following step: generate an alert if one or more portions of the sensor data exceeds a maximum value.
